(19) United States
(12) Patent Application Publication
(10) Pub. No.: US 2009/0102183 A1
(43) Pub. Date: Apr. 23, 2009

(54) Directional collar for pipe installation

(76) Inventor: Stacy Lynn Claus, Joshua, TX (US)

Correspondence Address: THE INVENTORS NETWORK, INC., 332 ACADEMY STREET, CARNEGIE, PA, 15106, US

(21) Appl. No.: 11/975,631

(22) Filed: Oct. 22, 2007

(51) Int. Cl. F16L 25/00

(52) U.S. Cl. 285/31

(57) ABSTRACT

A directional collar to facilitate the pulling and inserting of Natural Gas distribution, piping through underground boreholes or casing extending through such underground boreholes is placed on a section of piping to be pulled through the borehole or casing and having a beveled end that faces the direction the piping is to be pulled and a butt end facing the conventional joining collar so that after the ends of two adjacent piping sections have been secured by the joining collar the piping sections are guided into the borehole with the directional collar disposed adjacent the collar by the resistance of the directional collar against the borehole wall and as the piping sections are pulled through the borehole the beveled end deflects rocks, stones, and other debris away from the joining collar concomitant with the pulling of the piping sections thereby making pulling easier and more consistent.

### FIELD OF THE INVENTION

The present invention pertains to the installation of Natural Gas distribution piping, and more particularly pertains to a device that facilitates the pulling of utility piping through underground restrictions such as boreholes or casing.

### BACKGROUND OF THE INVENTION

Underground utility pipelines are a vital, yet a largely ignored, part of modern technology and industrial society. Such underground utility distribution piping largely comprises Natural Gas pipelines, and these lines extend to all manner of dwellings and structures ranging from residential, commercial, and industrial structures to even entertainment venues.

A number of factors and procedures must be considered and accomplished to prevent damage to existing utilities as well as the new extensions of pipeline. Generally, once the engineering drawings have been completed that graphically depict the destination, the surface is marked out with stakes and paint corresponding to the projected underground. Then the experienced utility crew with horizontal drilling machines, are employed to undertake the directional drilling that consists of drilling a pilot hole (which usually takes one day) and then taking the second day to actually install —pull through the borehole—the utility piping that connected sections or lengths of piping that actually comprise the line. In addition, service lines are sometimes inserted through existing abandoned casings for enhanced support and safety.

However, one common problem encountered in mechanically pulling lengths of piping, such as two inch and below distribution piping, through the borehole and/or any casings by directional pilling machinery, is that the collars that adjoin the ends of two adjacent sections of piping often drag against the circumjacent wall of the borehole. The dragging of the collars is caused by the rocky-type soil through which the borehole is formed. In addition, the collars that adjoin the ends of adjacent sections of piping often snag on unknown underground structures or protrusions, or just on the rocky soil, and such dragging force causes the drilling machinery to overwork and sometimes just pull the length of piping into a noodle shape because the pulling is not free, unencumbered, and consistent. Thus, the dragging force produced by the collars results in more wear and tear and the machinery and more down time to repair the damaged piping as well as increased labor costs and jobs not meeting their deadlines.

In view of the above problems and circumstances the prior art discloses a number of devices pertaining to tube and pipe construction and installation.

For example, the Pryor patent (U.S. Pat. No. 3,579,753) discloses a pipe-gripping apparatus that includes a tapered slip bowl having internal pipe-engaging slips that engage and hold a pipe extending through the tapered inside surface of the bowl by frictional forces.

The Luckenbill et al. patent (U.S. Pat. No. 3,669,475) discloses a compression coupling for connecting meeting ends of a pair of pipe sections that includes a tubular member having flared ends with each end including an end ring and gasket for joining and sealing the opposed ends of each pair of pipe sections together.

The Daspit patent (U.S. Pat. No. 4,127,289) discloses a coupling for pipelines that includes a coupling body placed about the pipe and an annular gripping cone annularly mounted to the pipe section and circumscribed by the coupling body so that compression bolts can be tightened thereby tightening an annular compression member against the gripping cone and causing the gripping cone to grip and hold the section of pipe.

The Broske patent (U.S. Pat. No. 3,742,582) discloses a method and apparatus for adjoining a relatively short length of conduit to a substantially continuous length of conduit for conveying fluid or gaseous media therethrough.

The Bird patent (U.S. Pat. No. 6,168,210 B1) discloses a pipe coupling for coupling and sealing adjacent ends of two pipe sections that includes specially formed gaskets and flanges that are urged together to sealingly engage the pipe sections.

The Adams et al. patent (U.S. Pat. No. 6,364,012 B1) discloses a drill pipe handling apparatus that includes a drill pipe having a large diameter section that mates with wedge members of a drilling rig for holding the drill pipe without damaging the drill pipe.

Nonetheless, despite the ingenuity of the above devices, there remains a need for a device that facilitates the pulling and installing of natural gas polyethylene mains and service lines by directional drilling bore machinery.

### SUMMARY OF THE INVENTION

The present invention comprehends a directional collar that is slip fit onto and over utility pipe, for example, used in replacing and extending natural gas distribution piping. Specifically, the directional collar is slip fit onto and over sections or lengths of utility piping joineding end-to-end by conventional joining collars. The directional collar enhances and eases the pulling of interconnected lengths or sections of piping through a predrilled borehole and/or casing by reducing the drag—resistance—of the conventional collar against the wall of a borehole and thus resulting in less damage to the piping and less stress and work on the machinery doing the pulling. As a result the job gets accomplished within the preset deadline thereby realizing cost savings for the contractor, the utility company, and the consumer.

The directional collar is a slip fit collar preferably two inches wide and having an angle or beveled end and an opposite flat butt end. The beveled end defines an angles exterior surface and impressed or formed on the angled surface of the beveled end are two spaced-apart directional arrows (spaced 180 degrees apart) that indicate the direction the piping is being pulled and the direction the beveled end of the directional collar should face for effectively deflecting rocks, stones, and other debris away from the conventional joining collar during the pulling operation. The directional collar also includes an aperture through which the length or section of utility piping is inserted for slidably disposing the directional collar on the length or section of piping. The installation crew places as many directional collars on sections of piping as they believe are needed to accomplish with minimal resistance a successful pulling operation for safe installation if natural gas polyethylene mains and services.

It is an objective of the present invention to provide a directional collar to facilitate the pulling and laying of underground utility piping that minimizes and prevents damage to the sections or lengths of natural gas distribution pipeline.

It is another objective of the present invention to provide a directional collar to facilitate the pulling and laying of underground conduit and piping that allows the particular job to be finished faster and with more consistency.

It is yet another objective of the present invention to provide a directional collar to safely facilitate the pulling of underground utility piping that allows the particular job to be finished faster and with more consistency.

It is still yet another objective of the present invention to provide a directional collar to facilitate the pulling and laying of underground utility piping that reduces the work output of the machinery because less resistance is encountered during the pulling of the piping through the underground borehole or casing.

It is still yet a further objective of the present invention to provide a directional collar to facilitate the pulling and laying of underground utility piping that allows a particular job to get finished on or before deadline thereby saving money for the contractor, the utility, and, ultimately, the consumer.

Still another objective of the present invention is to provide a directional collar to facilitate the pulling and laying underground utility piping that allows a longer runs of piping to be pulled further and without damage and prevents the long run of piping from being pulled into the machinery because of the dragging of the conventional collar against the annular wall of the borehole or casing.

Still yet a further objective of the present invention is to provide a directional collar to facilitate the pulling and laying of underground utility piping wherein should a leak be detected coming from the piping or service near the collared area where the ends of adjacent sections of piping are connected the directional collar can easily be slid down away from the conventional collar so that the damaged area of the piping can be repaired or replaced.

Another objective of the present invention is to provide a directional collar to facilitate the pulling, laying, and installation of underground utility piping wherein the directional collar is a slip fit-type collar for quick and easy disposition upon and over the length or section of conduit or piping.

Yet another objective of the present invention is to provide a directional collar to facilitate the pulling and laying of underground utility piping wherein the directional collar acts as a reemer and guide for the piping being pulled behind the directional collar thereby causing less strain on the pulling machinery and less work for the pulling machinery.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a side elevational view of the directional collar of the present invention illustrating the directional collar placed upon and slid toward the conventional collar joining the ends of the sections of piping or being pulled with the beveled or angled end of the directional collar facing the direction of pull;

FIG. 2 is a perspective view of the directional collar of the present invention illustrating the directional collar placed upon a section of piping and slid toward the conventional collar joining the ends of the adjacent sections or lengths of piping;

FIG. 3 is a side elevational view of the directional collar of the present invention illustrating the deflection of rocks and other debris by the beveled or angled end of the directional collar as the length of piping is being pulled through the borehole or casing and in the direction of the directional arrow;

FIG. 4 is a front elevational view of the directional collar of the present invention;

FIG. 5 is a sectional elevational view of the directional collar of the present invention taken along lines 5-5 of FIG. 4 illustrating the angled or beveled end and the blunt end; and

FIG. 6 is a rear elevational view of the directional collar of the present invention illustrating the blunt end and the aperture through which the section or length of piping extends.

### DETAILED DESCRIPTION OF THE PREFERRED EMBODIMENT

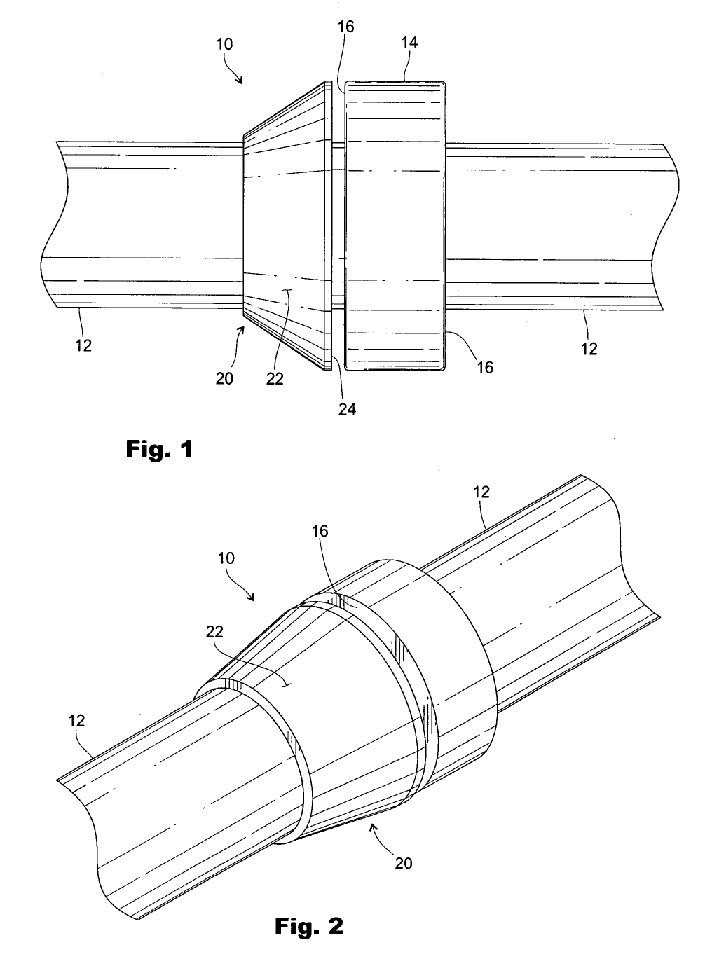

Illustrated in FIGS. 1-6 is a directional collar 10 to facilitate the pulling of Natural Gas distribution piping through a restriction. The directional collar 10 of the present invention is especially suitable for being slipped onto and over two inch diameter and less utility piping that is being pulled through a substantially horizontal underground borehole and/or casing by pulling equipment and machinery (not shown). The directional collar 10 is slipped onto and over lengths or sections of piping being pulled into and through the borehole in order to reduce, minimize, or eliminate the drag, resistance, or snagging that would normally occur from the conventional joining collar encountering rocks, stones, debris, roots, and other material in rocky-type soil through which the borehole extends. The directional collar 10 (one for each section of piping) is positioned in front of the conventional collar that joins two sections of piping, and faces the direction of pull for deflecting all manner of debris away from the conventional joining collar that is located immediately behind that respective directional collar 10.

Thus, for representative purposes, FIGS. 1-6 illustrate two adjacent sections, segments, or lengths of gas main piping 12 interconnected and adjoined by a conventional joining collar 14. The conventional collar 14 includes opposed blunt ends 16. The sections of adjoined piping 12 represent only one section or segment of the run of the gas main extending through the borehole. Slipped onto and over one section of piping 12 is the directional collar 10 with the directional collar 10 being located adjacent and immediately in front of the conventional joining collar 14.

Illustrated in FIGS. 1-6 is the directional collar 10 that is a slip fit collar having a width of at least two inches. The directional collar 10 includes an aperture 10 through which the sections of utility piping 12 extend, and thus the directional collar 10 defines an inside diameter and an outside diameter. The directional collar 10 includes a beveled or angled end 20 that defines an exterior sloping or beveled surface 22. The beveled end 20 can be cut at any angle between zero and 90 degrees, with 45 degrees being one preferred cut or slope. Opposite the beveled end 20 is a flat butt end 24 that extends generally perpendicular to the longitudinal extension of the length of conduit or piping 12 being pulled. Impressed upon the exterior sloping surface 22 of the beveled end 20 are a pair of directional arrows 26 spaced 180 degrees from each other. The directional arrows 26 assure that the directional collar 10 is placed upon the utility piping 12 with the beveled or angled end 20 of the collar 10 facing the direction that the piping is being pulled through the borehole.

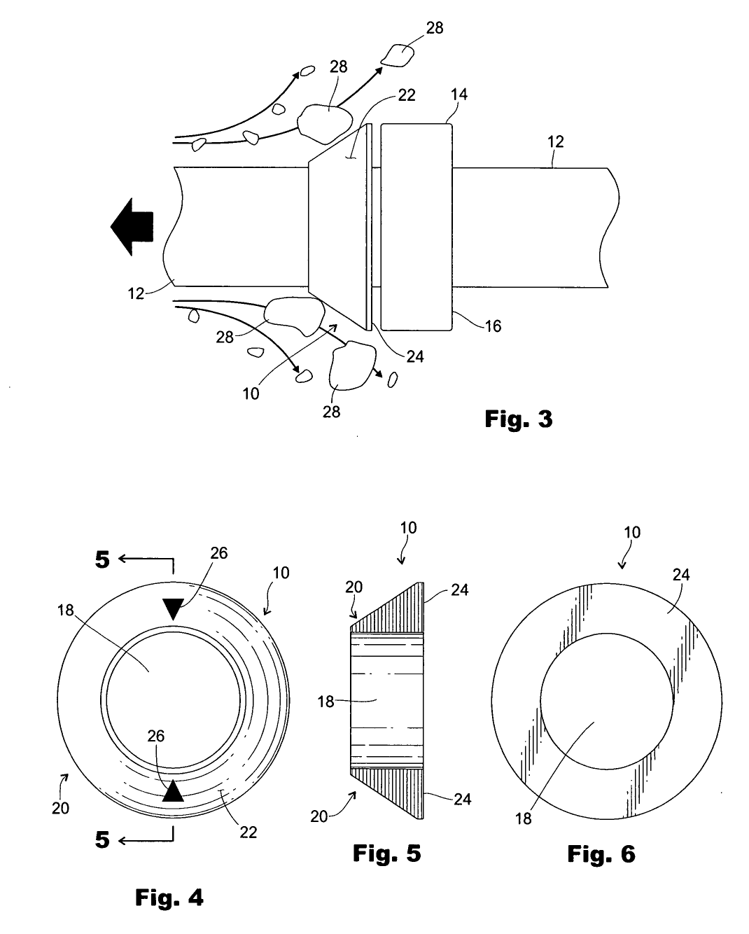

In operation the directional collar 10 would be slipped onto the length or section of piping 12 to be pulled through the borehole with the beveled end 20 facing the direction of pull and the butt end 24 facing the blunt end 16 of the conventional joining collar 14. Adjacent sections of piping 12 are then connected at the respective ends by the conventional joining collar 14 and then the piping 12 is guided into the borehole by regular insertion procedures for pulling therethrough. Once underground and disposed in the borehole the directional collar 10 will be pulled adjacent to and maintained in front of the conventional collar 14 deflecting all manner of debris 28, as shown in FIG. 3, away from the conventional joining collar 14 during the entire directional pulling process and thereby assuring an easy and consistent pull of the piping 12 through the borehole by the directional pulling machinery.

Although a preferred embodiment has been shown and described, it will be apparent to those skilled in the art that numerous modifications, alterations, and variations are possible and practicable without departing from the spirit of the invention or the scope of the appended claims.

I claim:

1. A directional collar to facilitate the pulling of utility piping through a underground borehole wherein two adjacent sections of utility piping are joined by a conventional joining collar with the directional collar placed in front of the conventional joining collar, the directional collar comprising:
a beveled end that defines a sloping surface;
an opposite flat butt end;
an aperture through which the section of piping extends;
a pair of directional arrows impressed upon the sloping surface of the beveled end and spaced 180 degrees from each other indicating the direction that piping is being pulled; and
whereupon the directional collar is slipped onto the piping and positioned adjacent the conventional collar prior to the guiding of the piping into the borehole so that as the piping is guided into the borehole and pulled through the borehole the beveled end faces the direction the piping is being pulled and thereby deflects rocks, stones, debris, and other underground material away from the conventional joining collar resulting in an easy and consistent pull of the piping through the borehole.
